(19) United States
(12) Patent Application Publication
(10) Pub. No.: US 2007/0214929 A1
(43) Pub. Date: Sep. 20, 2007

(54) Sawing machine with combination stand

(75) Inventors: Chia-Sheng Liu, Chiayi County (TW); Yu-Feng Chan, Kaohsiung County (TW)

Correspondence Address: BROWDY AND NEIMARK, P.L.L.C.;624 NINTH STREET, NW, SUITE 300, WASHINGTON, DC, 20001-5303, US

(73) Assignee: DURQ MACHINERY CORP., Taichung (TW)

(21) Appl. No.: 11/409,253

(22) Filed: Apr. 24, 2006

(30) Foreign Application Priority Data
Mar. 15, 2006 (TW) 95204288

(51) Int. Cl. B23D 45/06

(52) U.S. Cl. 83/477.2

(57) ABSTRACT

A sawing machine includes a base and four legs. The legs are connected to a bottom of the base, each of which has a first tube and a second tube, wherein the first tubes are connected to corners of the bottom of the base and the second tubes are detachably connected to the first tube respectively. The base has a storage space to receive the disassembled second tube.

### BACKGROUND OF THE INVENTION

1. Field of the Invention

The present invention relates generally to a machine tool, and more particularly to a sawing machine with a combination stand.

2. Description of the Related Art

FIG. 1 shows a conventional sawing machine 1, which includes a base 2, a working table 3 on the base 2 and four feet 4 on a bottom of the base 2. The feet 4 are fixed on corners of the base 2 that makes the sawing machine 1 with a huge size and hard to move.

To overcome the drawback of above sawing machine 1, an improved sawing machine has a foldable stand 5. As shown in FIG. 2, the stand includes a rectangular frame 6, a first foot assembly 7 and a second foot assembly 8. The sawing machine (shown as dot line on the frame 6) is out on the frame 6. The first foot assembly 7 includes two parallel first feet 7a and a linkage 7b, wherein ends of the first feet 7a are received in first slots 6a of the frame 6 for sliding, and the linkage 7b is connected to the first feet 7a. The second foot assembly 8 includes two parallel second feet 8a and a linkage 8b connected to the second feet 8a, wherein ends of the second feet 8a are received in second slots 6b of the frame 6 for sliding, and the second feet 8a are pivoted on the first feet 7a by two pins 9. User may exert the feet 7a or 8a to fold the stand 5.

The conventional foldable stand 5 has too much elements that increases the cost and makes the assembling process complex. In addition, the foldable stand 5 and the sawing machine are two independent pieces that is hard to store them.

### SUMMARY OF THE INVENTION

The primary objective of the present invention is to provide a sawing machine with a combination stand. The stand has two butt connected tubes to support the sawing machine. The tubes may be separated to be stored in the sawing machine that will take no extra space.

According to the objective of the present invention, a sawing machine includes a base and four legs. The legs are connected to a bottom of the base, each of which has a first tube and a second tube, wherein the first tubes are connected to corners of the bottom of the base and the second tubes are detachably connected to the first tube respectively. The base has a storage space to receive the disassembled second tube.

### BRIEF DESCRIPTION OF THE DRAWINGS

FIG. 1 is a perspective view of the conventional sawing machine with a fixed stand;

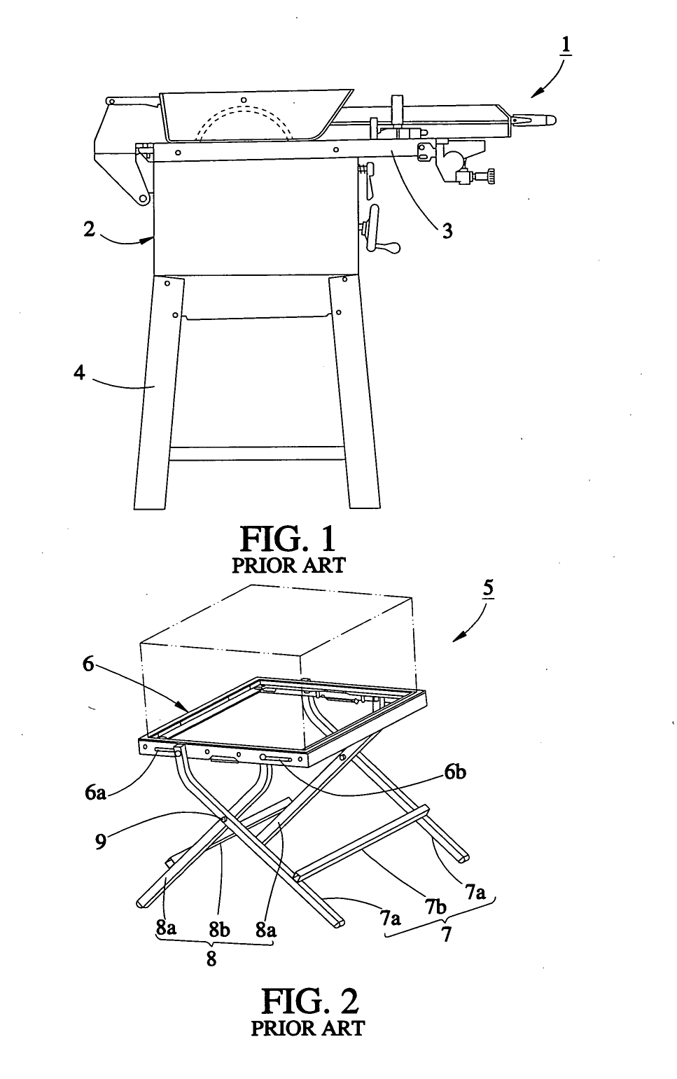

FIG. 2 is a perspective view of the conventional sawing machine with a foldable stand;

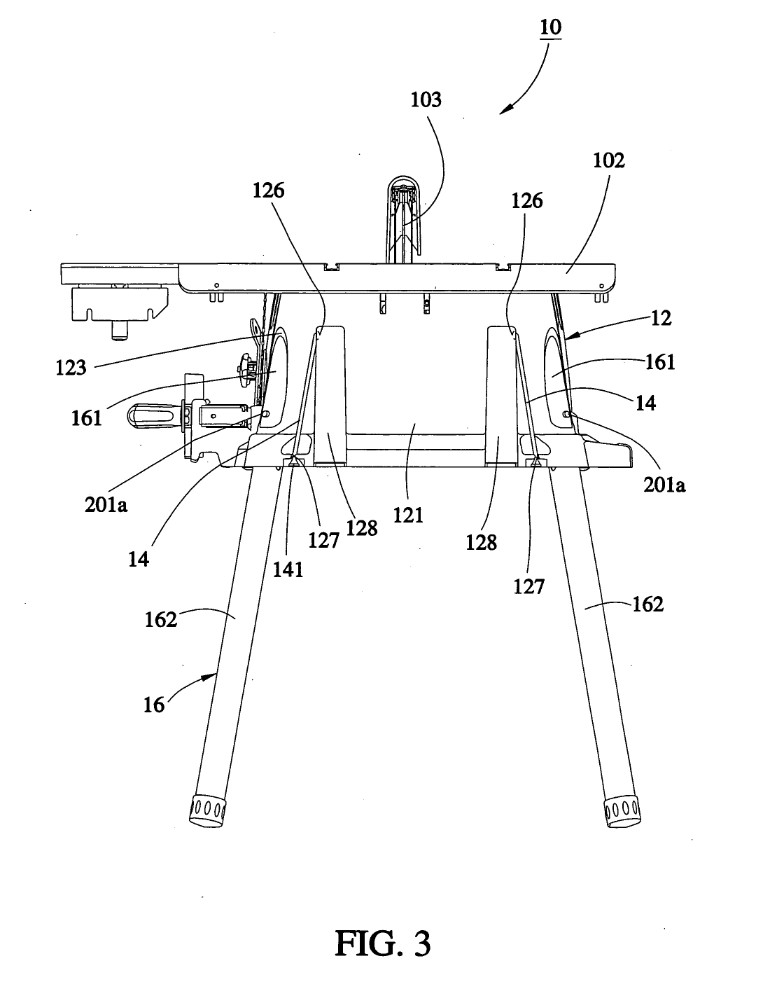

FIG. 3 is a front view of a first preferred embodiment of the present invention;

FIG. 4 is a bottom view of the first preferred embodiment of the present invention;

FIG. 5 is a front view of the first preferred embodiment of the present invention, showing the feet stored in the sawing machine;

FIG. 6 is a perspective view of the first preferred embodiment of the present invention, showing an exploded foot;

FIG. 7 is a perspective view of the first preferred embodiment of the present invention;

FIG. 8 and FIG. 9 are exploded views of the foot of the first preferred embodiment of the present invention;

FIG. 10 is a perspective view of the locking device;

FIG. 11 is a perspective view of the elastic member;

FIG. 12 is a perspective view of the first preferred embodiment of the present invention, showing the feet stored in the recesses;

FIG. 13 is a perspective view of a second preferred embodiment of the present invention;

FIG. 14 and FIG. 15 are exploded views of the foot of the second preferred embodiment of the present invention;

FIG. 16 is a front view of a third preferred embodiment of the present invention;

FIG. 17 is a right view of the third preferred embodiment of the present invention;

FIG. 18 is a perspective view of the third preferred embodiment of the present invention, showing the feet stored in the recesses;

FIG. 19 shows the base having closed cases one the junctions of the lateral plates; and

FIG. 20 shows the protrusions in the base.

### DETAILED DESCRIPTION OF THE INVENTION

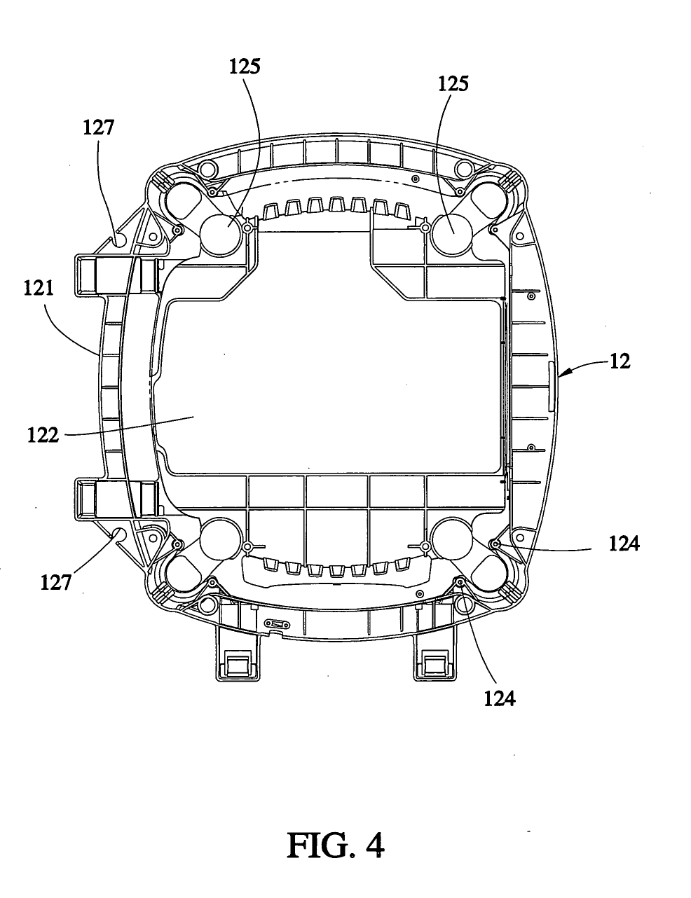

As shown in FIG. 3 to FIG. 6, a sawing machine 10 of the first preferred embodiment of the present invention includes a base 12, two elastic band 14, four feet 16, four locking devices 18 and four elastic members.

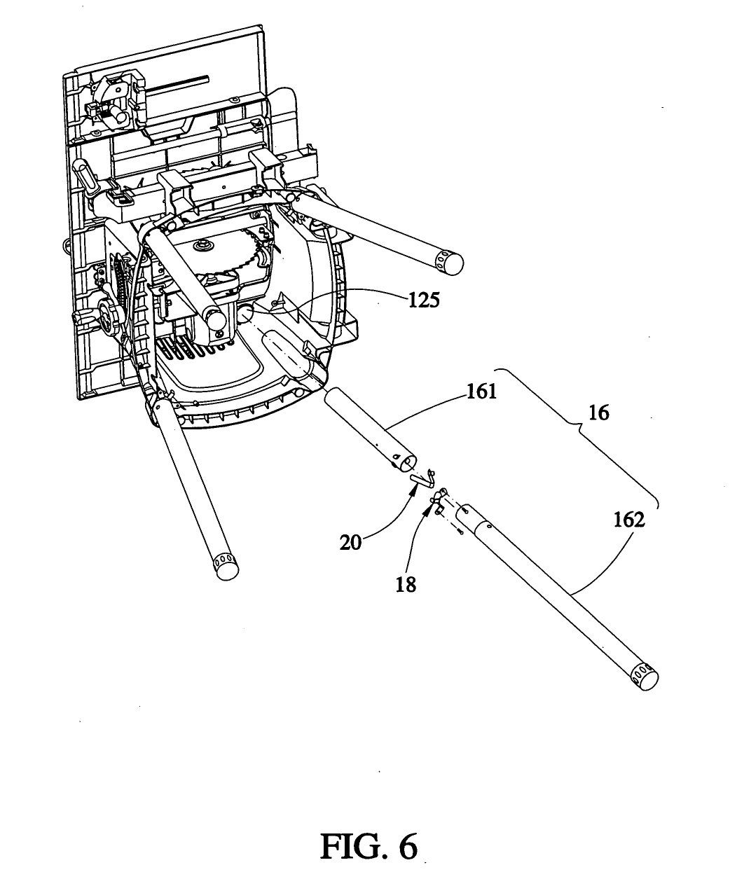

The base 12 consists of four lateral plates 121 and a top plate 122 connected to top ends of the lateral plates 121. The base 12 has bores 123 at junctions of the lateral plates 121 and eight threaded holes 124 on interior sides of the lateral plates 121, each two of which are located at opposite sides of the bore 123 respectively. The top plate 122 has fours round recesses 125 at corners thereof. One of the lateral plates 121 is provided with two through holes 126, two slots 127 at a bottom edge thereof and two L-shaped stop arms 128. It forms a storage space 129 between the stop arms 128 and the lateral plate 121, as shown in FIG. 5.

The elastic bands 14 are elastic ropes in the present invention, each of which has an end inserted into the through holes 126 of the lateral plate 121 and fastened to the base 12 and a head 141 on opposite end to be received and restricted in the slot 127.

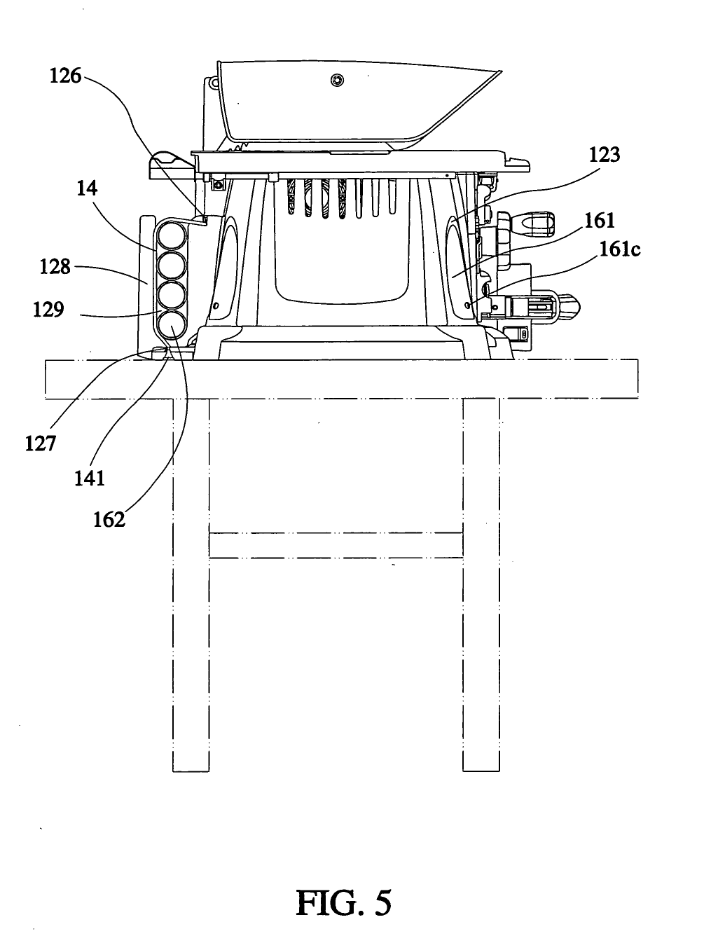

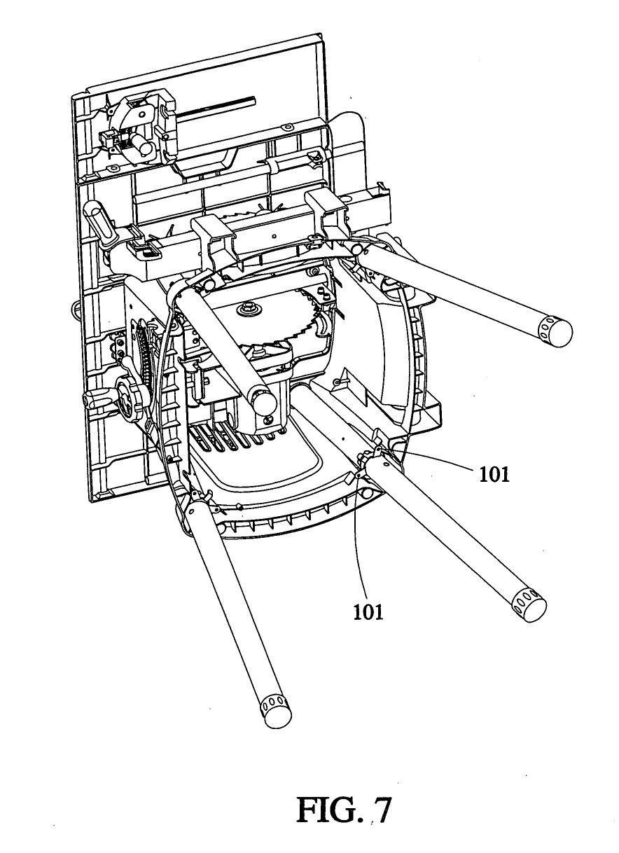

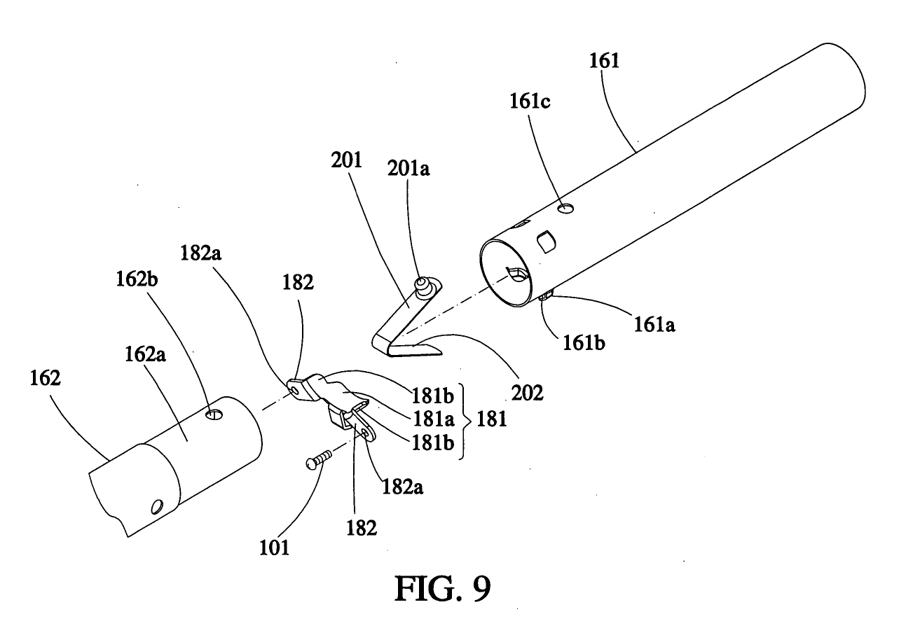

As shown in FIG. 6 to FIG. 9, each of the feet 16 consists of a first tube 161 and a second tube 162. The first tube 161 has an open bottom end and two L-shaped flanges 161 a on a circumference adjacent to the respectively bottom end, two openings 161b under suspended portions of the flanges 161a and a first hole 161c between the flanges 161a and a top end thereof. The first tubes 161 are inserted into the recesses 125 of the base 12 respectively and fixed to the base 12 by the locking devices 18, as shown in FIG. 4.

Each of the second tubes 162 has a connection section 162a, which has a smaller diameter to be inserted into the first tube 161, and a second hole 162b on a circumference of the connection section 162a. The second holes 162b of the second tubes 162 are aligned with the first holes 161c of the corresponding first tubes 161 respectively when the second tubes 162 are inserted into the first tubes 161.

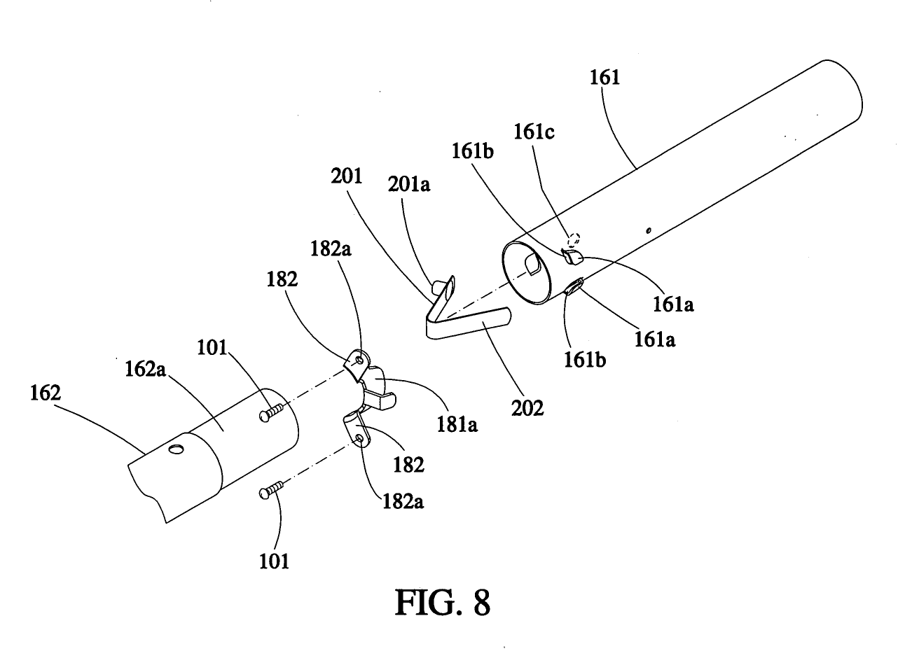

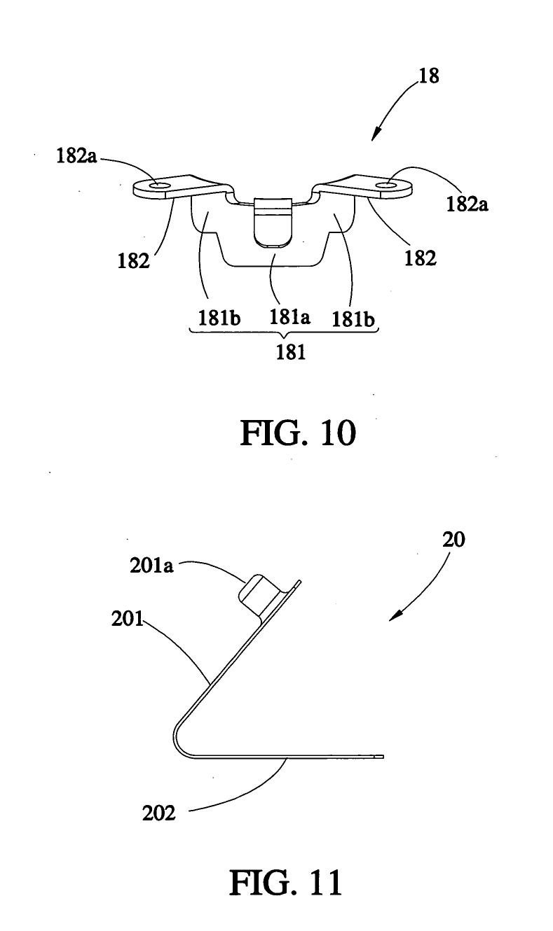

As shown in FIG. 10, each of the locking devices 18 is a plate fixed to a bottom of the first tubes 161, which includes a coupling portion and a fixing portion. The coupling portion is a plate 181 attached on the first tube 161. The plate 181 has a lock section 181a at a top thereof. The lock section 181a has a narrow width to be inserted into the opening 161b. The plate 181 further has a contacting section 181b at a bottom thereof. The contacting section 181b has a greater width touching opposite sidewall of the opening 161b. The fixing portion is two wing plates 182 projected from a bottom of the contacting portion 181b toward the interior sides of two of the neighboring lateral plates 121, each of which has a through hole 182a. The through holes 182a are aligned with the threaded holes 124 of the base 12 respectively when the locking portion 181 a of the plate 181 is inserted into the opening 161b, as shown in FIG. 7. Two bolts 101 are screwed into the threaded holes 124 of the base 12 through the through holes 182.

The locking devices 18 are coupled with the first tubes 161 respectively by the engagement of the locking sections 181a of the plates 181 with the openings 161b. The locking devices 18 further are coupled with the base 12 by the bolts 101 screwed into the threaded holes 124 through the through holes 182a of the wind plates 182 to fix the first tubes 161 on the corners of the base 12 respectively. The first holes 161c of the first tubes 161 are exposed through the bores 123 on the corners of the base 12, as shown in FIG. 5.

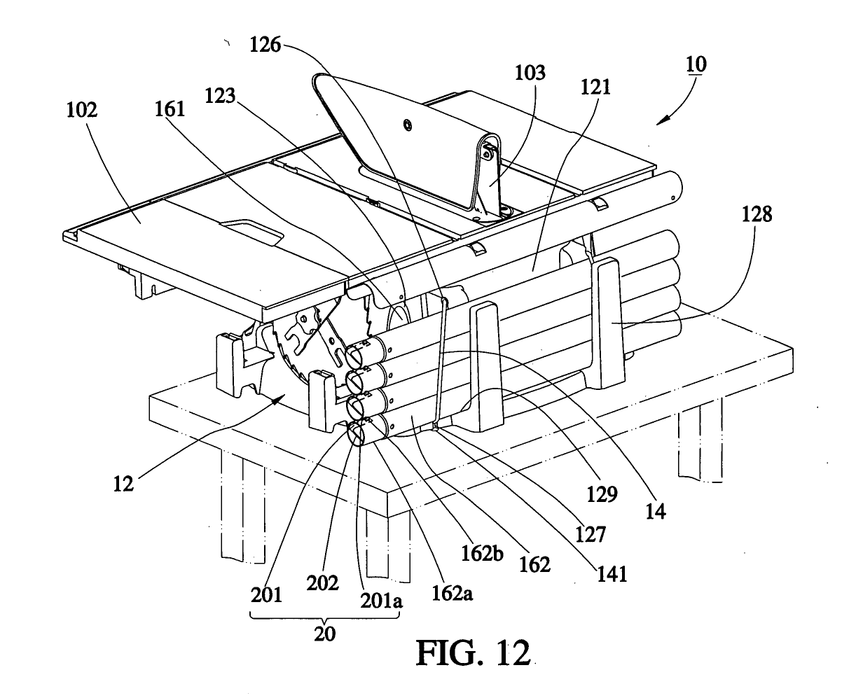

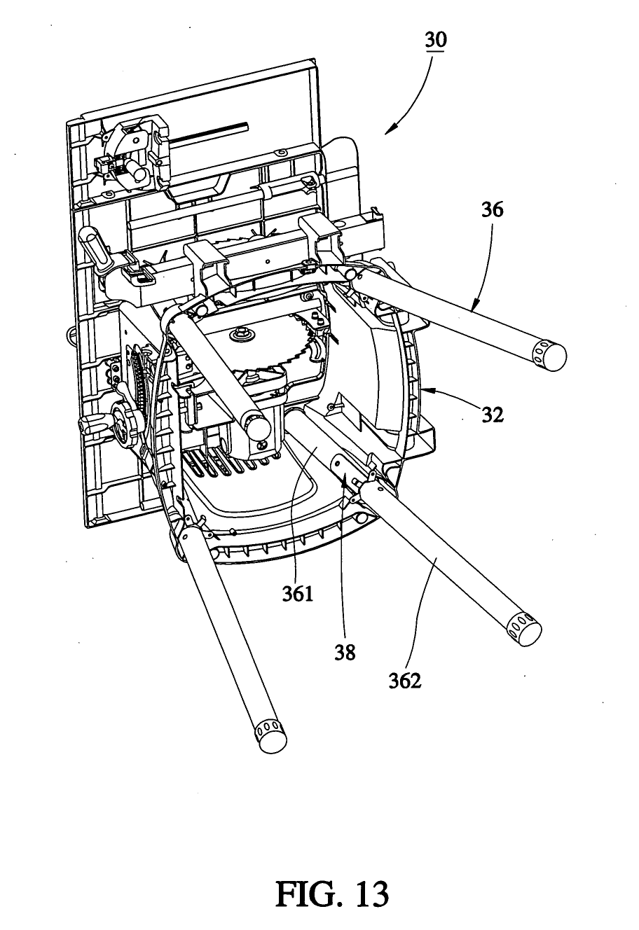

As shown in FIG. 11 and FIG. 12, the elastic members 20 are elastic plates with a first elastic piece 201 and a second elastic piece 202. The first elastic piece 201 has a protrusion 201a adjacent to a free end thereof. The elastic members 20 are connected to the connection portions 162a with an elastic force exerting free ends of the second elastic pieces 202 on the interior side 162 of the second tube 162 and the free ends of the first elastic pieces 201 on the interior side of the second tube 162 adjacent to the second hole 162b. Therefore, the protrusion 201a is received in the second hole 162b of the second tube 162, the first hole 161c of the first tube 161 and the bore 123 to couple the first tube 161 with the second tube 162, as shown in FIG. 9. On the contrary, the first and second tubes 161 may be separated by pressing end of the protrusion 201 a out of the first and second holes 161c, 161b.

Above are the elements and the relationship thereof of the sawing machine with the stand. As shown in FIG. 3, the protrusions 201 a of the elastic members 20 are through the first and second holes 161c, 161b respectively with the distal ends thereof exposed by the bores 123. The first and second tubes 161, 162 are coupled to form the legs 16. The legs 16 are tilted outwardly to support the base and the working table 102 and the sawing device 103 on the base 12 firmly on the ground.

To move or store the sawing machine 10, user may lean the 10 down to the ground or table, and then press the protrusions 201 a in the bores 123 to release and remove the second tubes 162 from the first tubes 161 respectively. The first elastic pieces 201 move the protrusions 201 back into the second holes 162b respectively when user releases the protrusions 201a. After all of second tubes 162 had been removed, the base 12 of the sawing machine 10 has a flat bottom, as shown in FIG. 12, to put it on any surface.

It is noted that user may put and stack the removed second tubes 162 in the storage space 129 of the base 12 of the sawing machine 10, as shown in FIG. 5 and FIG. 12, and wind the elastic bands 14 around the second tubes 162 and squeeze the heads 141 into the slots 127 of the lateral plate 121 to fasten the second tubes 162 in the storage space 129.

On the contrary, user only has to take the second tube 162 from the storage space 129 and press the protrusion 201a to fit the connection section 162a of the second tube 162 to the first tube 161. The protrusion 201a is moved into the first hole 161c by the first elastic piece 201 when the second hole 162b is aligned with the first hole 161c to lock the second tube 162 with the first tube 161. The rest second tubes 162 may be connected to the first tubes 161 by the same steps to form the four legs 16 of the sawing machine 10.

The detachable legs 16 of the sawing machine 10 may reduce the size thereof, and the detached second tubes 162 may still be carried in the storage space 129 pf the sawing machine 10, so that all of the elements of the sawing machine 10 may be moved in a time. The reduction of the size of the sawing machine 10 of the present invention facilitates the sawing machine 10 to store and takes less space. In addition, user only has to operate the protrusions 201a to assemble or disassemble the second tubes 162 that is a easier and faster way. The present invention also has the advantages of simpler structure and lower cost.

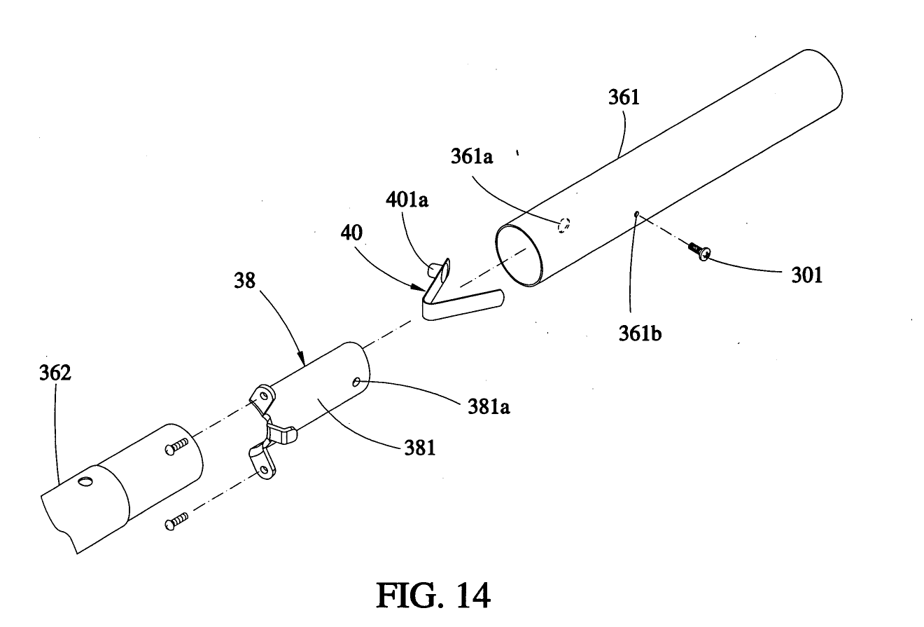

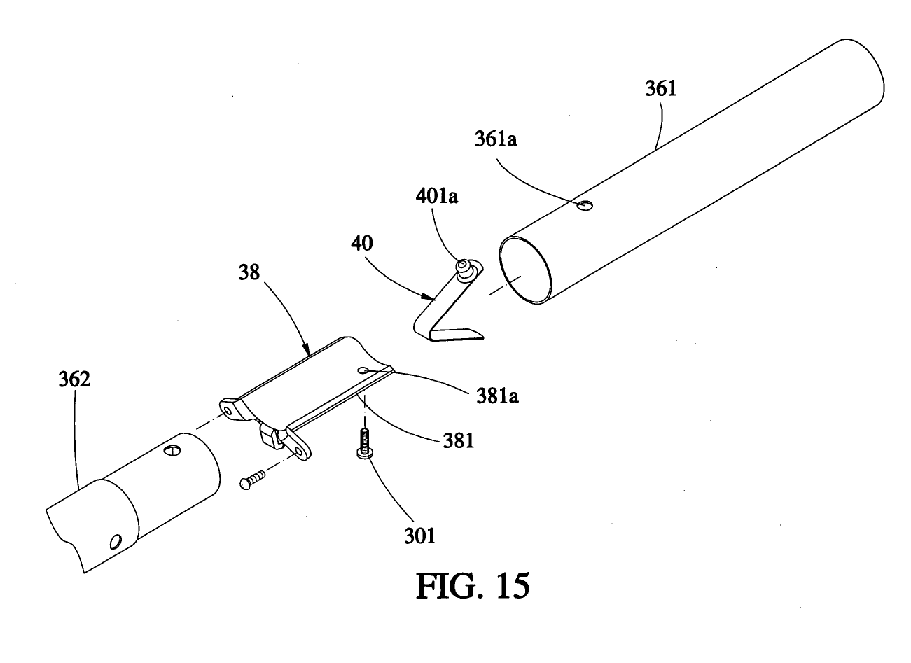

FIG. 13 to FIG. 15 show a sawing machine 30 of the second preferred embodiment of the present invention, which is similar to the sawing machine 10 of the first preferred embodiment, includes a base 32, two elastic bands (not shown), four legs 36, four locking devices 38 and four elastic members 40. The different places of the second preferred embodiment are the legs 36 and the locking devices 38 and the connection way of the legs 36 and the locking devices 38.

Each of the legs consists of a first tube 361 and a second tube 362, wherein the first tube 361 has a first hole 361a and a threaded hole 361b opposite to the first hole 361a. Each of the elastic members 40 has a protrusion 401a through the first hole 361a. The second tubes 362 are as same as the second tubes 162 of the first preferred embodiment, so I do not describe the detail.

Each of the locking devices 38 is made by a plate and fixed at a bottom of the first tube 361. Each of the locking devices 38 includes a coupling portion and a fixing portion. The coupling portion is an elongated plate 381 with a bore 381a. A bolt 301 is inserted into the bore 381a and screwed into the threaded hole 361b to fix the plate 381 on the bottom of the first tube 361. The fixing portion is as same as the fixing portion of the first preferred embodiment, so I do not describe the detail.

The second preferred embodiment provides the plate 381 of the locking devices 38 fixed to the first tube 361 by bolt that is a different way from the first preferred embodiment.

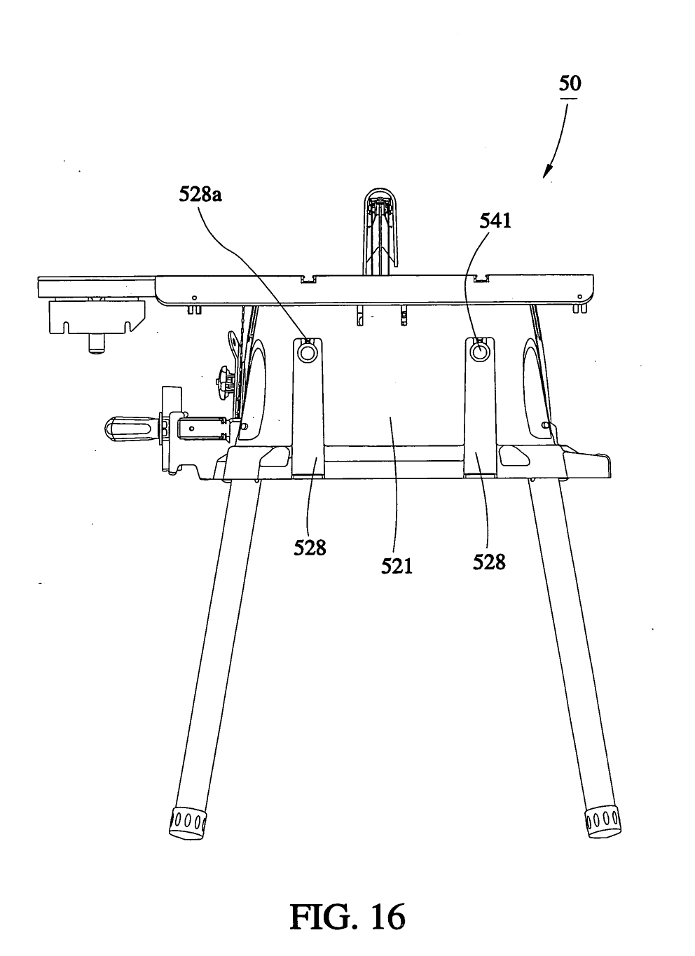

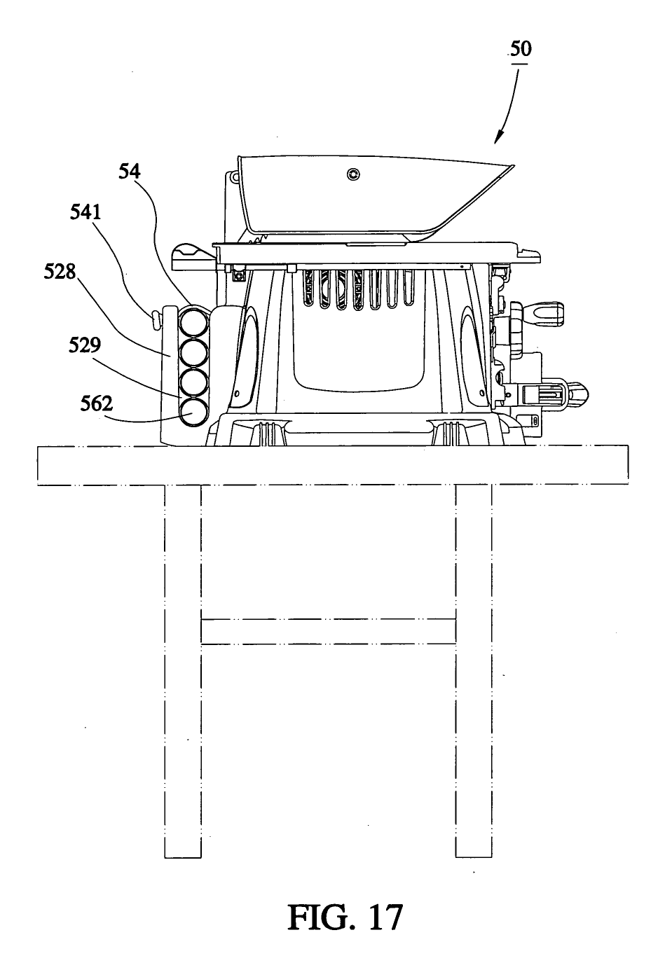

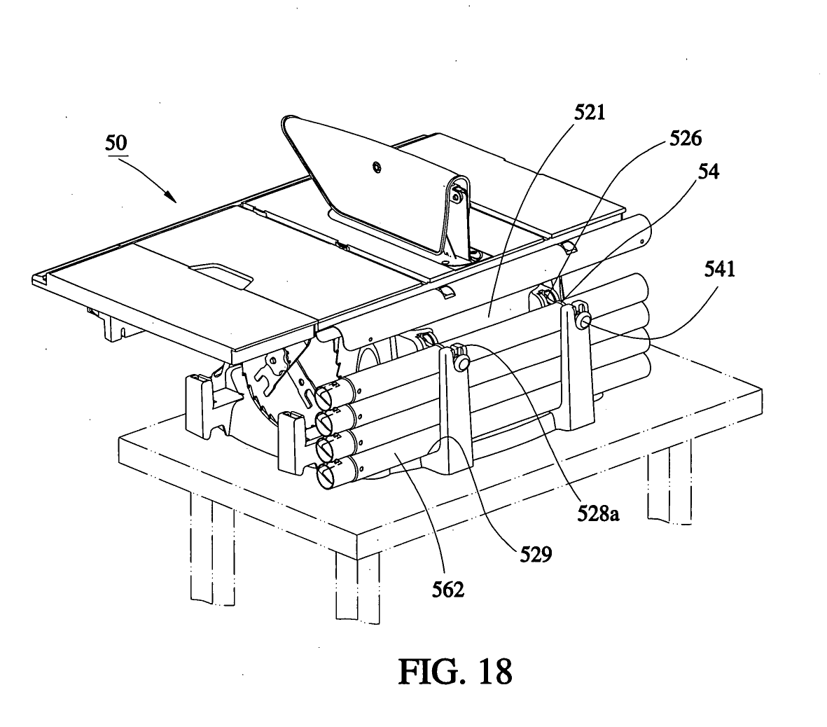

FIG. 16 to FIG. 18 show a sawing machine 50 of the third preferred embodiment of the present invention, which is similar to the sawing machine 10 of the first preferred embodiment, except that it has a different way of the elastic bands 54 fastening the second tubes 562 in the storage space 529.

The stop arm 528 has a gap 528a on a top thereof, and lateral plate 521 adjacent to the stop arm 528 has a band slot 526 to receive the elastic band 54. User may draw the elastic bands 54 across the second tubes 562 and engage the heads 541 of the elastic bands 54 with the gaps 528a to fasten the second tubes 562 in the storage space 529.

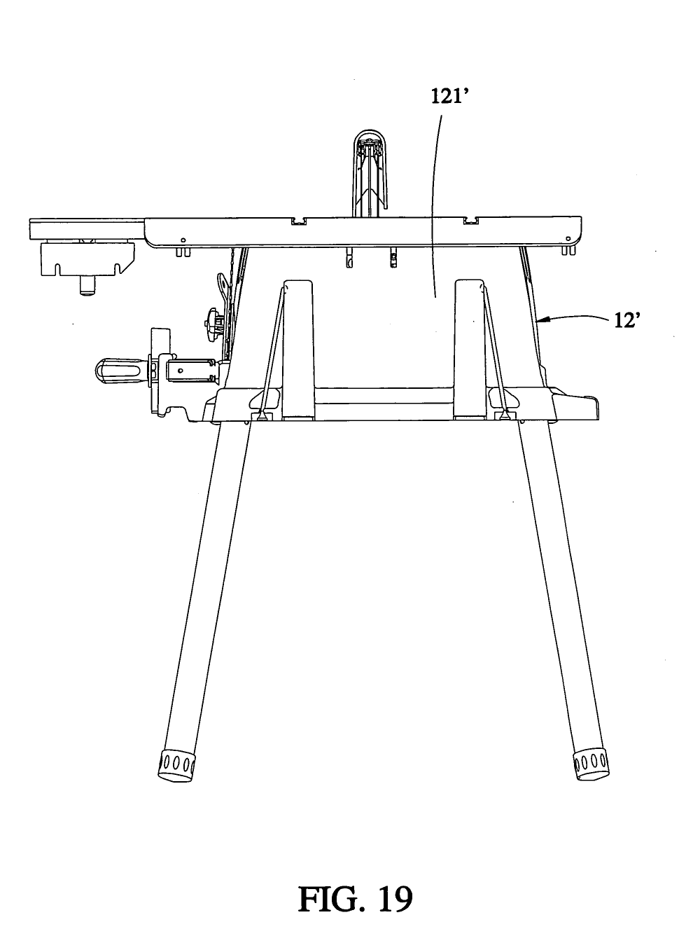

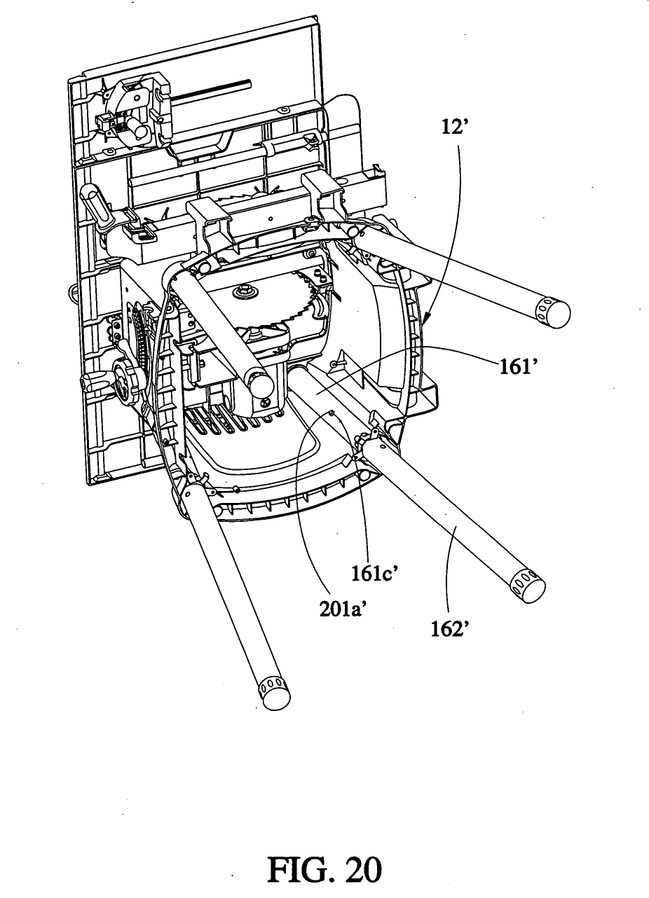

It is noted that the bores 123 of the base 12 of the sawing machine 10 of the first preferred embodiment expose the protrusions 201a to be operated by user. To prevent user from miss-operation of the protrusions 201a, the inventor provides another design shown in FIGS. 19 and 20. The lateral plates 121′ of the base 12′ have no bore at the junctions thereof. User has to insert the finger into the base 12′ from a bottom thereof to reach the protrusion 201a in the first hole 161c′ of the first tube 161′ when he/she wants to disassemble the second tubes.

The description above only includes few preferred embodiments and the equivalence of the present invention is still in the scope of the claim of the present invention.

What is claimed is:

1. A sawing machine, comprising:
a base having a storage space; and
four leg connected to a bottom of the base, each of which has a first tube and a second tube, wherein the first tubes are connected to corners of the bottom of the base and the second tubes are detachably connected to the first tube respectively or are received in the storage space.

2. The sawing machine as defined in claim 1, wherein the base has at least a stop arm, and between the stop arm and a side of the base is the storage space.

3. The sawing machine as defined in claim 2, further comprising at least an elastic band with an end connected to the base, wherein the base has a slot at the side thereof facing the stop arm, and the elastic band has a head at a distal end to wind the second tubes received in the storage space and engage the head with the slot.

4. The sawing machine as defined in claim 2, further comprising at least an elastic band with an end connected to the base, wherein the base has a gap on a top of the stop arm, and the elastic band has a head at a distal end to be engaged with the gap.

5. The sawing machine as defined in claim 1, further comprising four locking devices, each of which has a coupling portion and a fixing portion, wherein the base has four lateral plates and a top plate on tops of the lateral plates with four recesses on an interior side thereof, and each of the first tubes has a top end fixed in the recess, and the coupling portions of the locking device are fixed on bottoms of the first tubes, and the fixing portions of the locking devices are fixed on interior sides of the lateral plates.

6. The sawing machine as defined in claim 5, wherein each of the coupling portions of the locking device is a plate to be fixed to the first tube by bolts, and each of the fixing portions includes two wind plates projected from the plate, each of which has a through hole aligned with threaded holes on the lateral plates respectively to insert bolts into the through hole and screwed into the threaded holes.

7. The sawing machine as defined in claim 5, wherein the first tube has at least a suspended flange with an opening thereunder, and the coupling portion of the locking device is a plate inserted into the opening, and the fixing portion of the locking device includes two wing plate projected from the plate, each of which has a through hole aligned with threaded holes on the lateral plates respectively to insert bolts into the through hole and screwed into the threaded holes.

8. The sawing machine as defined in claim 6, further comprising four elastic members in the second tubes respectively, wherein the base has four bores at junctions of the lateral plate, and each of the first tube has a first hole, and each of the second tube has a connection section with a second hole to be fitted to the first tube, and each of the elastic members has a protrusions through the first hole and the second hole and with a distal end exposed by the bore respectively, whereby the protrusions may be pressed to leave first hole and the second hole such that the second tubes are release from the first tubes.

9. The sawing machine as defined in claim 8, wherein each of the elastic members has a first elastic piece with the protrusion thereon and a second elastic piece urging an interior side of the second tube.

10. The sawing machine as defined in claim 7, further comprising four elastic members in the second tubes respectively, wherein the base has four bores at junctions of the lateral plate, and each of the first tube has a first hole, and each of the second tube has a connection section with a second hole to be fitted to the first tube, and each of the elastic members has a protrusions through the first hole and the second hole and with a distal end exposed by the bore respectively, whereby the protrusions may be pressed to leave first hole and the second hole such that the second tubes are release from the first tubes.

11. The sawing machine as defined in claim 10, wherein each of the elastic members has a first elastic piece with the protrusion thereon and a second elastic piece urging an interior side of the second tube.
